(19) United States
(12) Patent Application Publication
(10) Pub. No.: US 2008/0038591 A1
(43) Pub. Date: Feb. 14, 2008

(54) FUEL STORAGE DEVICE CAPABLE OF DETECTING LIQUID LEVEL

(76) Inventors: HSI-MING SHU, Taipei (TW); Tsang-Ming Chang, Taipei (TW); Chien-An Chen, Kaohsiung (TW); Wen Jui Chuang, Kaohsiung (TW)

Correspondence Address: G. LINK CO., LTD., 3550 BELL ROAD, MINOOKA, IL, 60447, US

(21) Appl. No.: 11/836,968

(22) Filed: Aug. 10, 2007

(30) Foreign Application Priority Data
Aug. 14, 2006 (CN) 200620124195.1

(51) Int. Cl. G01F 23/00; H01M 8/00

(52) U.S. Cl. 429/12

(57) ABSTRACT

A fuel storage device, which contains liquid fuel needed by a fuel cell and is capable of detecting liquid level, includes a main fuel storage tank, a liquid level tube and a liquid level gage. The main fuel storage tank contains liquid fuel. The liquid level tube is disposed independent of the main fuel storage tank and connected to the main fuel storage tank with a short tube section. The liquid level gage is attached to the liquid level tube for measuring liquid level of the liquid fuel.

### BACKGROUND OF THE INVENTION

1. Field of the Invention

The present invention is related to a fuel storage device and particularly to a fuel storage device capable of detecting liquid level and containing liquid fuel needed by a fuel cell.

2. Brief Description of the Related Art

The fuel cell is a power generation device by means of chemical energy in the fuel and oxidizer converting to electrical energy via electrode reaction. Many fuel cells are available in the market and they can be classified into different types. If the fuel cells are classified with different properties of electrolytes, there are five different electrolyte fuel cells: alkaline fuel cell, phosphoric acid fuel cell, proton exchange membrane fuel cell, molten carbonate fuel cell and solid state oxide fuel cell. Wherein, the proton exchange membrane fuel cell further includes the so-called direct methanol fuel cell, which employs methanol as the fuel directly without needing to change to hydrogen in advance. Further, the direct methanol fuel cell provides one of highly developed technologies and target applications of the direct methanol fuel cell includes such as large scale power plant, electric generator for automobile and portable power source.

However, a problem regarding steadiness of power output has to be overcome for the liquid fuel cell such as the direct methanol fuel cell in the process toward commercialization. Hence, it is essential that quantity of the liquid fuel in the liquid fuel supply device maintains at a reason amount in order to avoid short of fuel. Short of fuel is a core factor to result in the liquid fuel cell being incapable of supplying power normally. Therefore, a liquid level detecting device becomes important to trace amount of the liquid fuel in the fuel storage device constantly. That is, the liquid level of the fuel in the fuel storage device has to be detected if it keeps above a preset level such that quality of power supply can be maintained and electronic products can be prevented from damage caused by unsteady power supply.

### SUMMARY OF THE INVENTION

An object of the present invention is to provide a fuel storage device capable of detecting liquid level with which the liquid fuel needed by the fuel cell can be monitored constantly and an immediate response can be conducted once it is short of the liquid fuel.

In order to achieve the preceding object, a fuel storage device, which contains liquid fuel needed by a fuel cell and is capable of detecting liquid level, according to the present invention includes a main fuel storage tank, a liquid level tube and a liquid level gage. The main fuel storage tank contains liquid fuel. The liquid level tube is disposed independent of the main fuel storage tank and connected to the main fuel storage tank with a short tube section. The liquid level gage is attached to the liquid level tube for measuring liquid level of the liquid fuel.

### BRIEF DESCRIPTION OF THE DRAWINGS

The detail structure, the applied principle, the function and the effectiveness of the present invention can be more fully understood with reference to the following description and accompanying drawings, in which:

FIG. 1 is a sectional view of the first embodiment of a fuel storage device capable of detecting liquid level according to the present invention;

FIG. 2A is a perspective view of the second embodiment of a fuel storage device capable of detecting liquid level; and

FIG. 2B is a sectional view of FIG. 2A.

### DETAILED DESCRIPTION OF THE INVENTION

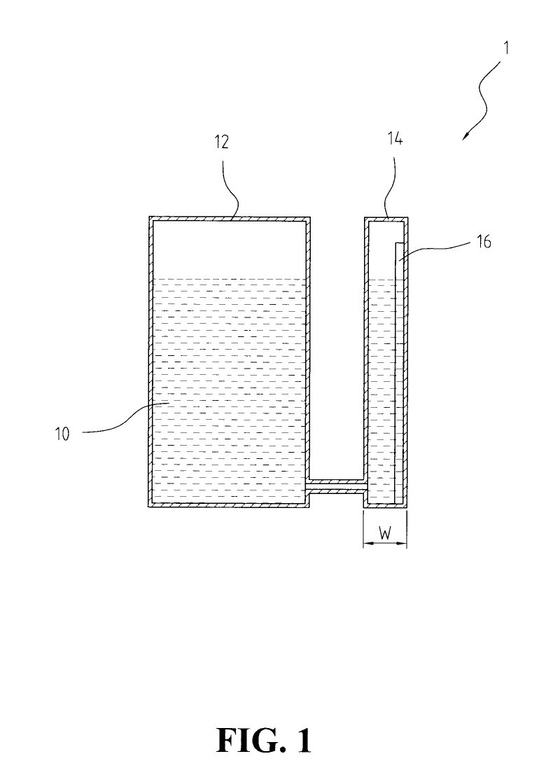

Referring to FIG. 1, the first embodiment of a fuel storage device capable of detecting liquid level according to the present invention is illustrated. It can be seen in FIG. 1 that a fuel storage device 1 of the present is capable of containing liquid fuel needed by a fuel cell. If the fuel storage device 1 is provided for a direct methanol fuel cell, the liquid fuel 10 in the fuel cell is pure methanol with high consistency or diluted solution of methanol.

The fuel storage device 1 shown in FIG. 1 includes a main storage tank 12, a liquid level tube 14 and a liquid level gage 16. The main storage tank 12 contains the liquid fuel 10 such that the main storage tank 12 can be a conventional high consistency liquid fuel tank or a mixing tank. The main storage tank 12 connects with the liquid level tube 14 with a short tube section. The liquid level tube 14 is arranged to be independent of the main storage tank 12 and is designed to have a small space preferably with a diameter between 1 mm and 3 mm in order to obtain an economical size. Further, the liquid level gage 16 is provided at the level tube 14 for measuring level of the liquid fuel 10 in the fuel storage device 1. The level scale 16 shown in FIG. 1 can be an electronic type level scale and is disposed inside or outside the liquid level tube 14 to adhere the wall of the liquid level tube 14 for the liquid level being sensed without contacting the fuel. The electronic type level gage can be implemented to measure and record the liquid level of the liquid fuel 10 continuously with pneumatics, hydraulics, buoyant balls or supersonic waves. Besides, the surface of the liquid level gage 16 is treated to resist corrosion and/or acid against the highly corrosive and acid liquid fuel 10.

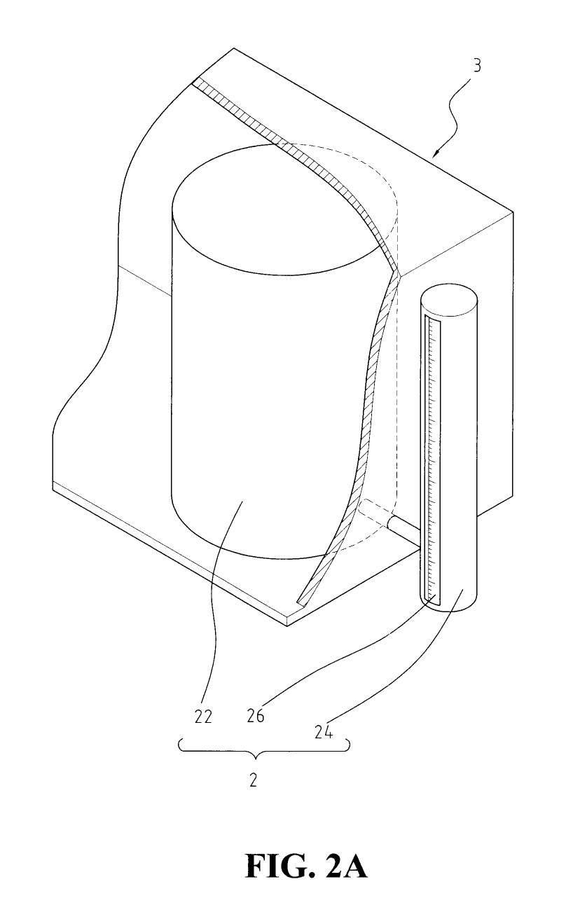

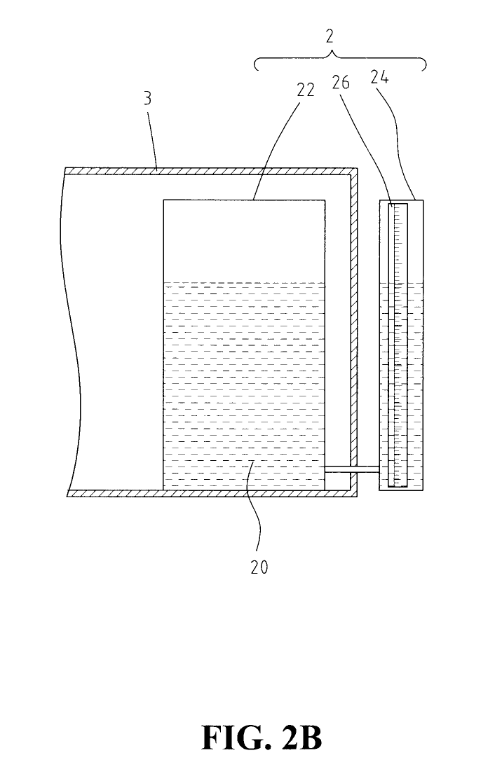

Referring to FIGS. 2A and 2B, the second embodiment of a fuel storage tank capable of detecting liquid level according to the present invention is illustrated to be associated with a fuel cell device 3. It can be seen in FIG. 2B that the fuel storage device 2 includes a main storage tank 22, a liquid level tube 24 and a liquid level gage 26. The main storage tank 22 communicates with the liquid level tube 24 with a short tube section. The liquid level tube 24 is disposed to be independent of the main storage tank 22. The liquid level gage 26 is disposed at the liquid level tube 24 for measuring the liquid level of the liquid fuel 20 in the fuel storage device 2. The liquid level gage 26 is implemented with a water level rule, which has a scale marked on the wall of the liquid level tube 24 as shown in FIG. 2A. It is clearly seen that the main storage tank 22 is disposed in the fuel cell device 3 and the liquid level tube 24 is disposed outside the fuel cell device 3. Hence, the liquid level of the fuel 20 in the main storage tank 22 can be observed by sight directly by means of the water level rule of the liquid level tube 24.

It is appreciated that the fuel storage device according the present invention has applied the principle of manometer tube to measure quantity of the liquid fuel 20 in the main storage tank (12, 22) with the level gage (16, 26) of the liquid level tube (14, 24) such that the problem of the level gage (16, 26) being incapable of being built in the main storage tank (12, 22) can be solved and the amount of the fuel left in the fuel cell can be known from outside easily.

While the invention has been described with referencing to preferred embodiments thereof, it is to be understood that modifications or variations may be easily made without departing from the spirit of this invention, which is defined by the appended claims.

What is claimed is:

1. A fuel storage device, which contains liquid fuel needed by a fuel cell and is capable of detecting liquid level, comprising:
a main fuel storage tank containing liquid fuel;
a liquid level tube being disposed independent of said main fuel storage tank and connected to said main fuel storage tank with a short tube section; and
a liquid level gage being attached to said level tube for measuring a liquid level of said liquid fuel.

2. The fuel storage device as defined in claim 1, wherein said liquid level gage is an electronic type level gage.

3. The fuel storage device as defined in claim 1, wherein said liquid level gage is a water level rule with the scale thereof being marked on the wall of said liquid level tube.

4. The fuel storage device as defined in claim 1, wherein said liquid fuel is diluted methanol solution.

5. The fuel storage device as defined in claim 1, wherein said liquid fuel is pure methanol solution.

6. The fuel storage device as defined in claim 1, wherein said liquid level tube has a diameter between 1 mm and 3 mm.

7. The fuel storage device as defined in claim 1, wherein surface of said liquid level gage is anti-corrosively and/or anti-acidly treated.

8. The fuel storage device as defined in claim 1, wherein said fuel cell is a direct methanol fuel cell.
